(19) United States
(12) Patent Application Publication
(10) Pub. No.: US 2018/0141294 A1
(43) Pub. Date: May 24, 2018

(54) TIRE BUILDING DRUM

(71) Applicant: Marangoni Meccanica S.p.A., Rovereto (IT)

(72) Inventors: Viscardo Baldoni, Rovereto (IT); Flavio Boscolo, Trambileno Fraz. Porte (IT)

(21) Appl. No.: 15/572,015

(22) PCT Filed: May 5, 2016
(86) PCT No.: PCT/IB2016/052578

§ 371 Date: Nov. 6, 2017

(30) Foreign Application Priority Data
May 5, 2015 (EP) 15166480.2
Aug. 10, 2015 (IT) 102015000043692

(51) Int. Cl. B29D 30/24

(52) U.S. Cl. CPC B29D 30/24; B29D 2030/2657

(57) ABSTRACT

A tyre building apparatus (1) comprising a drum (2) formed by two half-drums (7, 8), which are specular with respect to a centre plane (4) of the drum (2), are axially relatively movable and are angularly coupled to a respective shaft (5; 16) to rotate about a common axis (3); the apparatus (1) being equipped with a first actuating device (6) to rotate the drum (2) about the axis (3) and continuously vary the distance between the two half-drums (7, 8); and a second actuating device (39) to radially move the drum (2) between a configuration of maximum radial expansion and a configuration of maximum radial contraction; the first actuating device (6) being placed outside the drum (2) to axially move the half-drums (7, 8) via a relative telescopic movement of the respective shafts (5, 16); and the second actuating device (39) being arranged on board the drum (2) and being operable independently of the first actuating device (6) and of the movement of the shafts (5, 16) of the two half-drums (7, 8).

### TECHNICAL FIELD

The present invention relates to a tyre building drum.

More specifically, the present invention relates to a tyre building drum comprising a building drum of the radially collapsible and expandable type, also known as a “positive” drum.

### BACKGROUND ART

In the known art, a building drum of the above-mentioned type is normally composed of two half-drums, which are arranged on opposite sides of a centre-line plane perpendicular to the rotation axis of the drum and are each provided with a respective plurality of segments movable from a radially expanded position, in which the segments, taken as a whole, define a continuous outer surface of the drum on which the tyre carcass is built, and a radially collapsed position, in which the tyre carcass can be axially removed from the drum.

In order to allow tyres of different widths to be built, positive drums must also be adjustable in the axial direction. In this case, the drum comprises a group of central segments arranged between the groups of segments of the two half-drums and defining a central annular band of the drum's outer surface. In some drums, axial adjustment of the drum is manually implemented by dismantling the central segments and replacing them with segments of different width. Drums of this type are described, for example, in U.S. Pat. No. 5,320,701 and U.S. Pat. No. 3,817,812.

Although simple from the mechanical standpoint, this solution entails drawbacks mainly identifiable in that the replacement of the central segments requires relatively long machine downtimes and the need to have a storeroom with a large number of central segments of different widths.

There are numerous solutions in the known art to overcome these problems that, in general, contemplate keeping the central segments axially stationary and moving the two half-drums automatically and simultaneously in opposite directions, via opportune actuator means, in such a way as to provide continuous adjustment of the drum's overall width.

A solution of this type is described, for example, in EP 1 286 827.

Although the more recent technical solutions have enabled overcoming a major part of the drawbacks of traditional drums, currently known drums that are radially movable and axially adjustable with automatic systems only allow performing limited axial relocation, normally only intended for the extraction process of the carcass built on drum.

### DISCLOSURE OF INVENTION

The object of the present invention is to provide an improved tyre building apparatus, this apparatus enabling wide axial relocations that allows continuous adjustment of the tyre width in production and also eliminates the need for central spacer elements in order to adjust the aforesaid width.

According to the present invention a tyre building drum is provided as set forth in claim 1 and, preferably, as set forth by any of the successive claims directly or indirectly appended to claim 1.

### BRIEF DESCRIPTION OF THE DRAWINGS

The invention will now be described with reference to the accompanying drawings, which illustrate some non-limitative embodiments, in which:

FIG. 1 shows, in side elevation and partially in section, a preferred embodiment of the apparatus according to the present invention, where the drum is arranged in an axially fully extended configuration;

FIG. 2 show the apparatus in FIG. 1 in a different operating configuration, i.e. with the drum arranged in an axially fully collapsed configuration;

FIGS. 3 and 4 show a perspective view, with parts removed for clarity, of the drum in FIG. 1 in a radially expanded and in a radially contracted configuration, respectively;

FIG. 5 shows a side elevation of the drum in FIG. 1 or 2,

FIGS. 6 and 7 show the drum of FIG. 5 in respectively different operating configurations;

FIG. 8a shows, on an enlarged scale, the drum of FIG. 1 in a radially expanded and axially expanded configuration (top half of drum) and a radially expanded and axially contracted configuration (bottom half of the drum);

FIG. 8b shows, on an enlarged scale, the drum of FIG. 1 in a radially contracted and axially expanded configuration (top half of drum) and in a radially contracted and axially contracted configuration (bottom half of drum);

FIG. 9 is a section, along line IX-IX, of the drum in FIG. 8a;

FIG. 10 is a section, along line X-X, of the drum in FIG. 8b;

FIG. 11 is a section, along line XI-XI, of the drum in FIG. 9;

FIG. 12 is a section, along line XII-XII, of the drum in FIG. 10;

FIG. 13 shows, on the upper part, the drum of FIG. 12 arranged in the radially expanded configuration to the left of the drum's centre plane and in the radially collapsed configuration to the right of the centre plane; and, on the lower part, shows a variant of the drum in FIG. 12 in the same operating configurations of the upper part;

FIG. 14 shows, in side elevation with parts removed for clarity, the drum of FIG. 2 and, in particular, part of the radial actuating mechanism;

FIG. 15 shows, in side elevation with parts removed for clarity, the drum of FIG. 1 and, in particular, part of the above-mentioned radial actuating mechanism;

FIG. 16 shows a detail of FIG. 14 or 15;

FIGS. 17 and 18 show a detail of the drum in FIG. 12 in respectively different operating configurations;

FIGS. 19 and 20 schematically show two of the operational phases of the drum of the present invention; and

FIGS. 21 and 22 show a variant of the apparatus in FIGS. 1 and 2, respectively, in corresponding operating configurations.

### BEST MODE FOR CARRYING OUT THE INVENTION

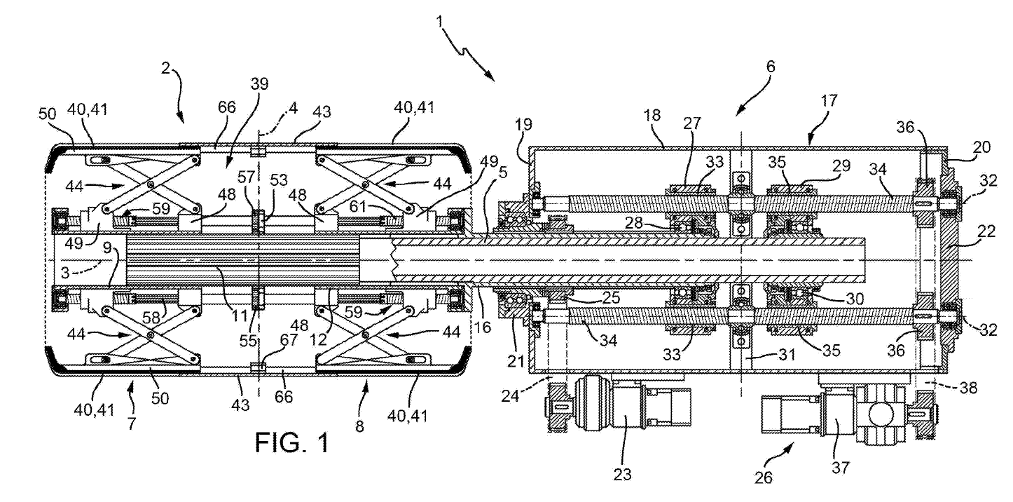

In FIG. 1, reference numeral 1 indicates, as a whole, a tyre building apparatus (not shown).

The apparatus 1 comprises a drum 2, which has a longitudinal axis 3 and a centre plane or centre line 4 perpendicular to the longitudinal axis 3 and is mounted on the free end of a central shaft 5, which is coaxial to the longitudinal axis 3 and defines the rotating output member of an actuating unit 6.

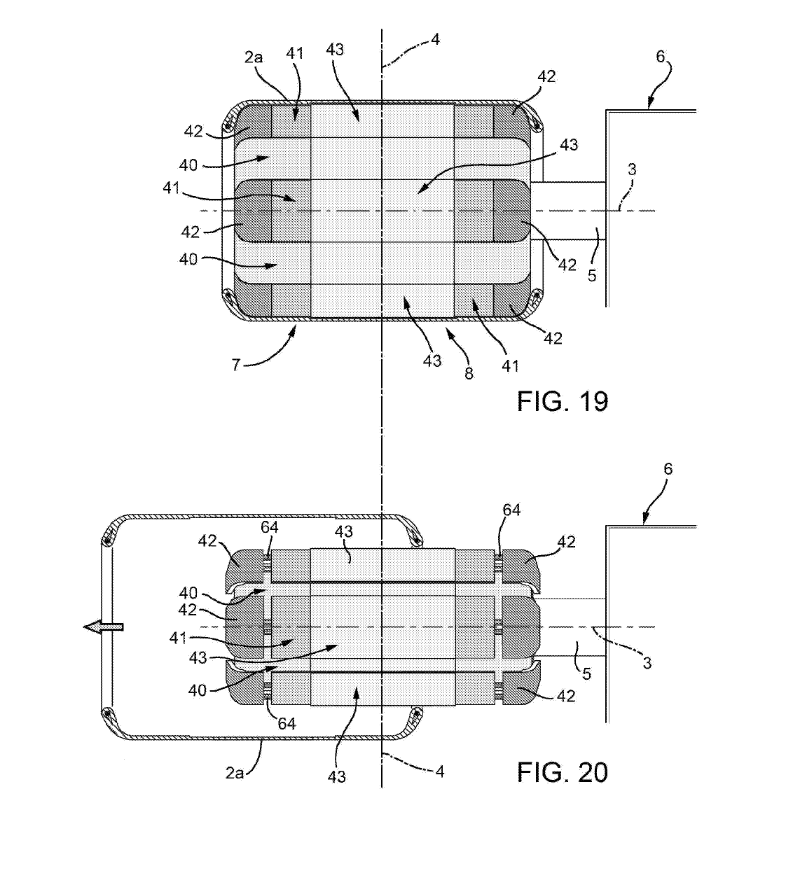

The drum 2 is of the radially collapsible type, i.e. it is configured so that it can be moved, in a manner that will be described in detail hereinafter, between a radially expanded position, in which the drum has a continuous cylindrical outer surface on which, in use, the tyre carcass 2a is built, and a radially collapsed position, in which the tyre carcass 2a can be axially removed from the drum 2 (FIGS. 19 and 20).

In addition to being radially movable, the drum 2 is configured to be axially adjustable, in a continuous manner, so that it can assume different widths and therefore allow tyres of various widths to be built.

The drum 2 comprises two half-drums 7 and 8, which are arranged in specular positions with respect to the centre plane 4, are coaxial to the longitudinal axis 3 and are axially movable with respect to each other along the longitudinal axis 3, away from and towards the centre plane under the action of the actuating unit 6.

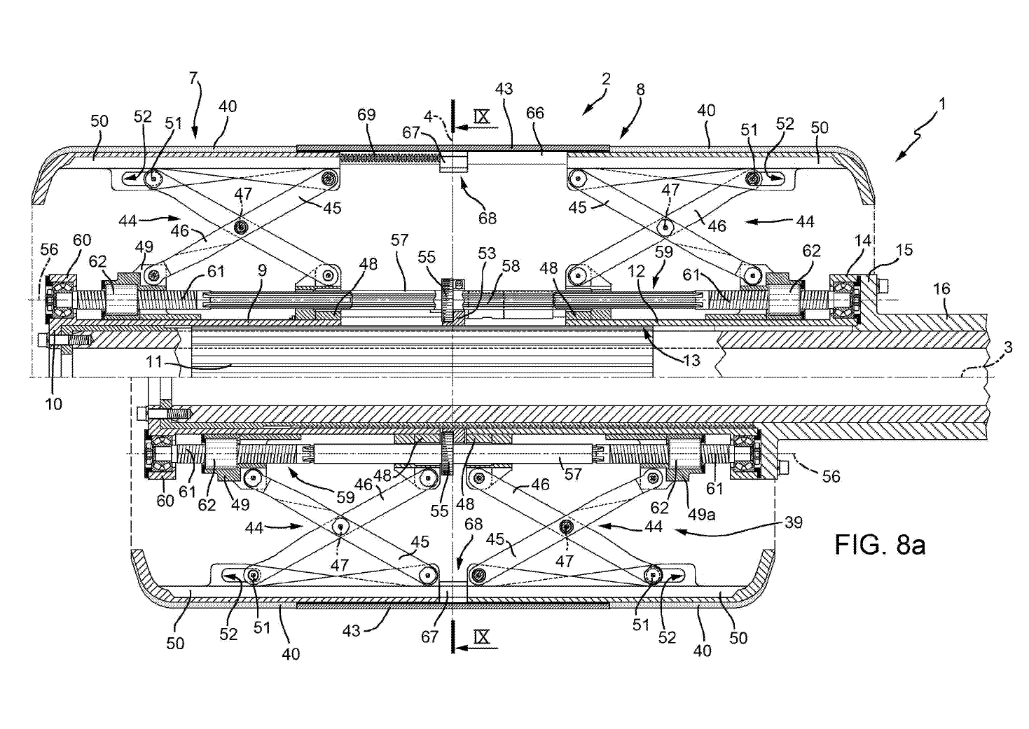

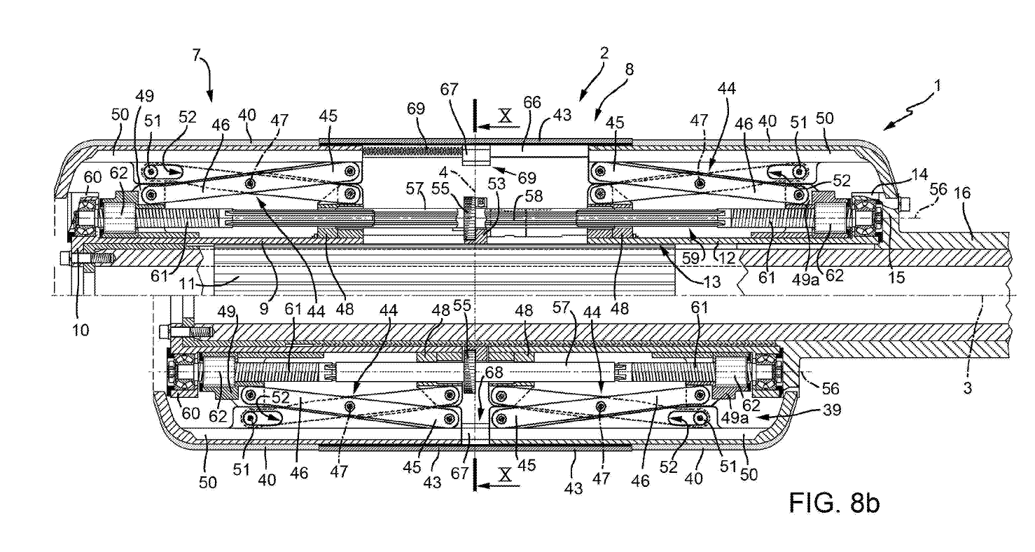

In particular, as shown in FIG. 1, and in greater detail in FIGS. 8a and 8b, half-drum 7 is mounted on the central shaft 5 via a tubular body 9, which is coaxial to the longitudinal axis 3 and at one axial end has an annular transverse wall 10 rigidly fixed, by screws, to the distal end of the central shaft 5. At the axially opposite end, the tubular body 9 has a splined inner surface angularly coupled to a splined portion 11 of the central shaft 5.

The tubular body 9 is therefore axially and angularly integral with the central shaft 5.

In turn, half-drum 8 comprises a tubular body 12, which is coaxial to the longitudinal axis 3 and is coupled to the central shaft 5 in an axially sliding and angularly fixed manner by means of a splined coupling 13 between the inner surface of the tubular body 12 and the splined portion 11 of the central shaft 5.

At its axial end facing the outside of the drum 2, tubular body 12 has an annular flange 14, which rigidly connects tubular body 12 to an annular flange 15 integral with a sleeve 16, which is coaxial to the longitudinal axis 3 and is coupled in an axially sliding manner to a portion of the central shaft 5 protruding outside the drum 2.

The function of the actuating unit 6 is to give the drum 2 both rotary motion about the longitudinal axis 3 and the axial adjustment movement of the half-drums 7 and 8 along the longitudinal axis 3.

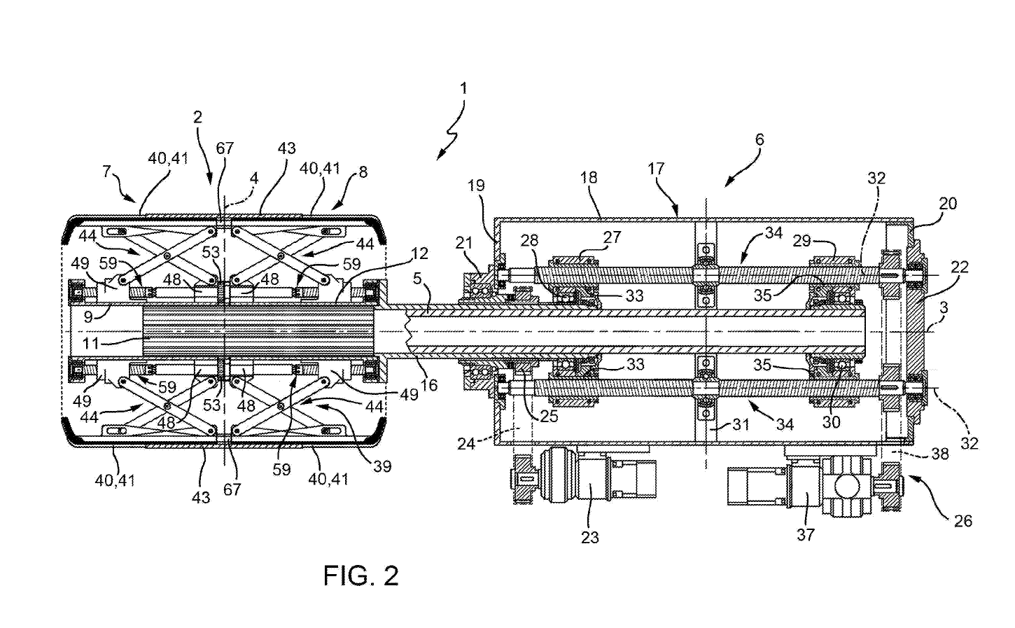

As shown in FIGS. 1 and 2, the actuating unit 6 comprises a frame 17, which is supported by a bedplate (not shown) and comprises a lateral wall 18 coaxial to the longitudinal axis 3 and two end walls 19 and 20 transversal to the longitudinal axis 3.

End wall 19 faces towards the drum 2 and supports the sleeve 16 in a rotatable and axially sliding manner through the interposition of a bearing support 21.

Rotary motion is applied to the drum 2 by the actuating unit 6 via a motor 23, which is angularly coupled, by a belt 24, to a pulley 25 integral with the bearing support 21 and, in consequence, with the sleeve 16. In this way, rotary motion is transmitted by the pulley 25 to the sleeve 16 and from the sleeve 16 to the central shaft 5 through the splined coupling 13; in turn, the central shaft 5 and the sleeve 16 transmit the rotary motion to half-drum 7 and half-drum 8, respectively.

The axial position of the half-drums 7 and 8 along the longitudinal axis 3 is regulated by an actuator device 26 constituting part of the actuating unit 6 and designed to apply a relative telescopic movement to the central shaft 5 and the sleeve 16 along the longitudinal axis 3.

In the example shown in FIGS. 1 and 2, the actuator device 26 is configured to simultaneously move the central shaft 5 and the sleeve 16 in opposite directions, so as to keep the position of the centre plane 4 along the longitudinal axis 3 fixed during the axial adjustment of the drum 2, while the half-drums 7 and 8 move away from or towards the centre plane 4.

To this end, the actuator device 26 comprises an annular plate 27, which is coaxial to the longitudinal axis 3, is traversed by the central shaft 5 and is coupled in a rotatable and axially fixed manner to the free end of the sleeve 16 by a bearing 28 coaxial to the longitudinal axis 3. The actuator device 26 also comprises a further annular plate 29, which is coaxial to the longitudinal axis 3, is traversed by the central shaft 5 and is coupled in a rotatable and axially fixed manner to the central shaft 5 by a bearing 30 coaxial to the longitudinal axis 3.

The plates 27 and 29 are arranged specularly on opposite sides of an annular intermediate wall 31 of the frame 17 parallel to the end walls 19 and 20 and traversed in a rotatable manner by the central shaft 5.

Plate 27 has two through holes with respective axes 32 parallel to the longitudinal axis 3 and located on opposite sides of the longitudinal axis 3. Each hole is engaged by a respective lead nut 33, each of which is integral with plate 27 and is engaged by a respective screw 34 coaxial to the respective axis 32 and forming, with the associated lead nut 33, a corresponding lead nut and screw coupling.

Similarly, plate 29 has two through holes, each of which is coaxial to a respective axis 32 and is engaged by a respective lead nut 35, each of which is integral with plate 29 and is engaged by one of the screws 34 to form, with the associated lead nut 35, a corresponding lead nut and screw coupling.

Each screw 34 is supported in a rotatable and axially fixed manner by the end walls 19 and 20 and the intermediate wall 31, which demarcates two portions of reverse threading on the screw 34. In particular, each portion of screw 34 located between end wall 19 and the intermediate wall 31 engages a respective lead nut 33, and each portion of screw 34 located between the intermediate wall 31 and end wall 20 engages a respective lead nut 35.

Close to end wall 20, each screw 34 has a respective pulley 36 fitted that, together with the other pulley 36 fitted on the other screw 34, is connected to a motor 37 by a belt or chain drive 38. The screws 34, pulleys 36, motor 37 and belt or chain drive 38, together with the plates 27 and 29 with the lead nuts 33 and 35, form part of the actuator device 26.

According to a variant that is not shown, the actuator unit 26 comprises only one screw 34 and only one pulley 37.

As shown in FIG. 1, in a configuration of maximum axial extension of the drum 2, i.e. of maximum distance between the half-drums 7 and 8, the plates 27 and 29 are located along the screws 34 close to the intermediate wall 31. If, starting from this configuration, the screws 34 are set in rotation, the plates 27 and 29 specularly move away from each other and from the intermediate wall 31. Since the sleeve 16 is axially integral with plate 27 and the central shaft 5 is axially integral with plate 29, the movement of the plates 27 and 29 causes translation of the sleeve 16 towards the centre plane 4 and translation in the opposite direction of the central shaft 5 inside the sleeve 16, with the consequent movement of the half-drums 7 and 8 towards each other and towards the centre plane 4. FIG. 2 shows a configuration of maximum axial contraction of the drum 2, where the half-drums 7 and 8 are close together.

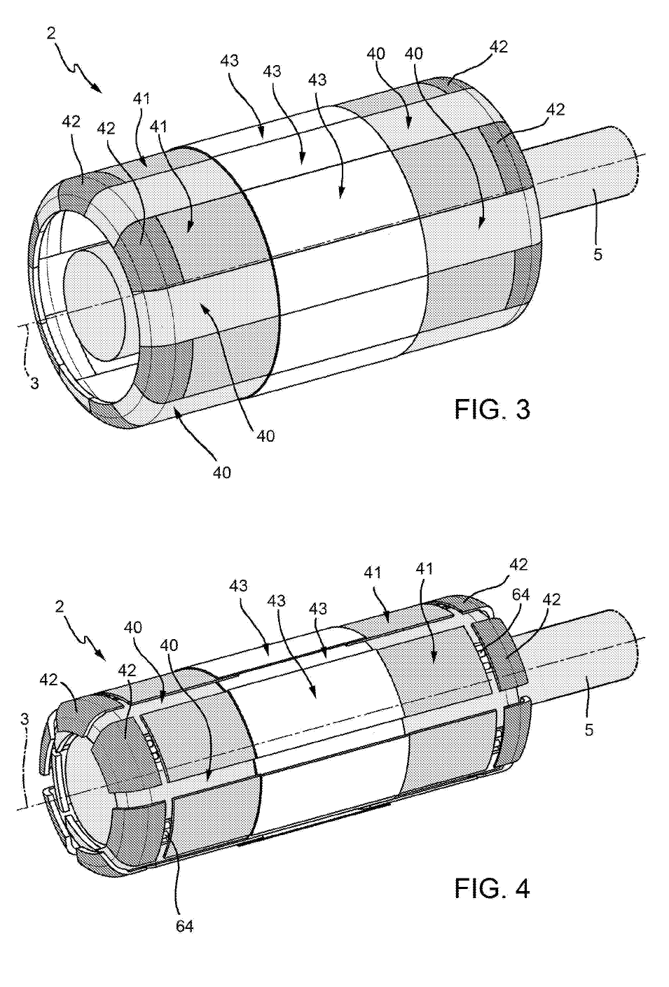

As explained above and shown in FIGS. 3 and 4, the drum 2 is movable between a configuration of maximum radial expansion (FIGS. 3 and 19), in which it exhibits a substantially continuous outer surface, and a configuration of maximum radial contraction (FIGS. 4 and 20).

To this end, the outer surface of each half-drum 7 and 8 is radially subdivided into a respective plurality of segments, which are designed to be moved radially to and from said configuration of maximum radial expansion by an actuator device 39 mounted on board the drum 2 and completely independent of the actuating unit 6 and, in particular, of the actuator device 26 that controls the axial position of the two half-drums 7 and 8 along the longitudinal axis 3.

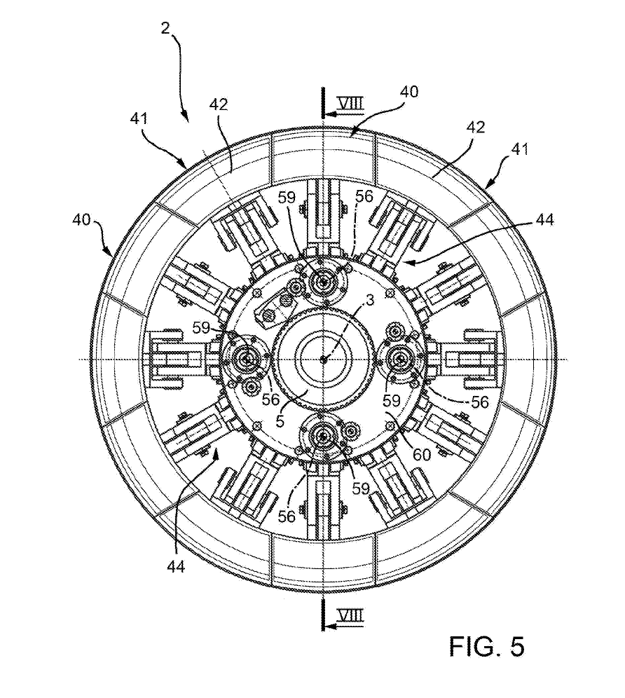

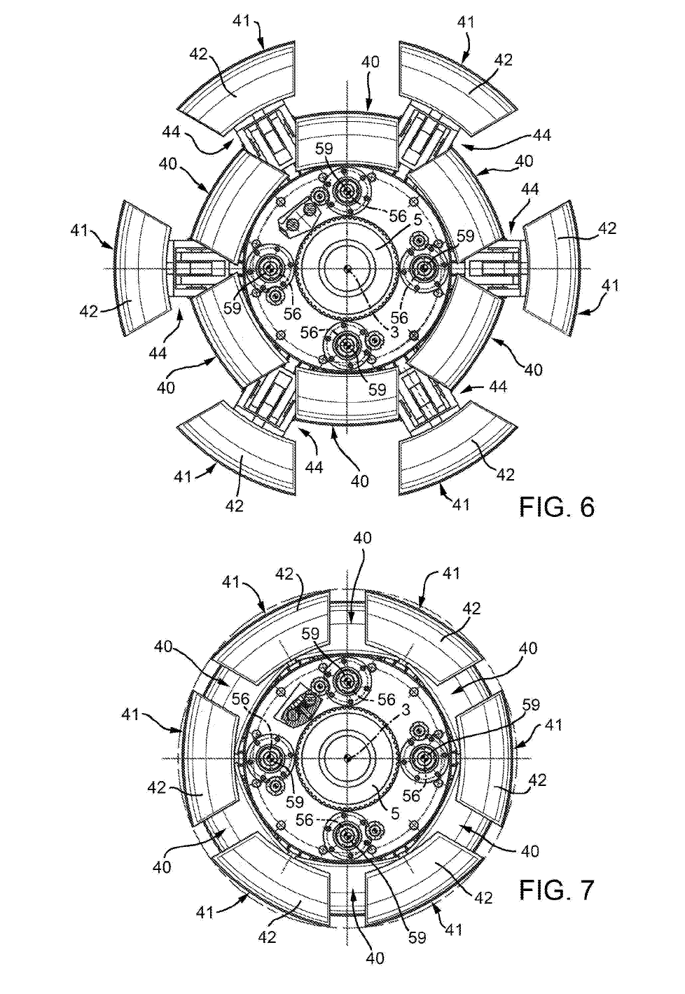

As shown in FIG. 4 and in FIGS. 5, 6 and 7, to allow the complete collapse and overlapping of the segments in the configuration of maximum radial contraction, each half-drum 7 and 8 comprises two series of segments arranged in alternating positions about the longitudinal axis 3: a series of circumferentially narrower segments 40 and a series of circumferentially wider segments 41 that, when the drum 2 is collapsed, are set in motion after segments 40 so as to partially overlap segments 40 when the drum 2 reaches the configuration of maximum radial contraction (FIGS. 4, 6 and 7).

In particular, each narrow segment 40 of one of the half-drums 7 or 8 is axially aligned with a corresponding segment 40 of the other half-drum 8 or 7 and comprises a main portion coaxial to the longitudinal axis 3 and having, at the respective axial end of the drum 2, a fixed end portion bent towards the centre of the drum 2.

Each wide segment 41 of one of the half-drums 7 or 8 is axially aligned with a corresponding segment 40 of the other half-drum 8 or 7 and comprises a main portion, which is coaxial to the longitudinal axis 3 and carries at the respective axial end of the drum 2, a connected bent end portion 42, which is movable, as will be seen below, with respect to the respective main portion and, together with the bent end portions of other segments 41 and the bent end portions of segments 40 of the same half-drum, defines a respective annular side of the drum 2.

The central portion of the drum 2 is also defined by a plurality of central segments 43, each of which is arranged between, and axially aligned with, a respective pair of segments 40 or 41 and is radially movable, together with the respective pair of segments 40 or 41, to and from the configuration of maximum radial expansion (FIG. 3).

In the specific embodiments shown in the accompanying drawings, each half-drum 7 and 8 comprises a series of six segments 40 and a series of six segments 41, for a total of twelve segments. This total number of segments can be different.

As shown in FIGS. 8a and 8b, each segment 40 and 41 is mounted on the respective half-drum 7 or 8 via a respective pantographic lever mechanism 44 that defines part of a drive mechanism interposed between the segments 40 and 41 and the actuator device 39 to move the segments 40 and 41 radially.

The lever mechanisms 44 of each half-drum 7 and 8 each comprise a pair of levers 45 and 46 hinged to each other to oscillate about a respective axis 47, on a radial plane passing through the longitudinal axis 3, and connect the respective segments 40 or 41 to the tubular body 9 or 12, respectively, by connection means common to all the lever mechanisms 44 of the half-drum 7 or 8.

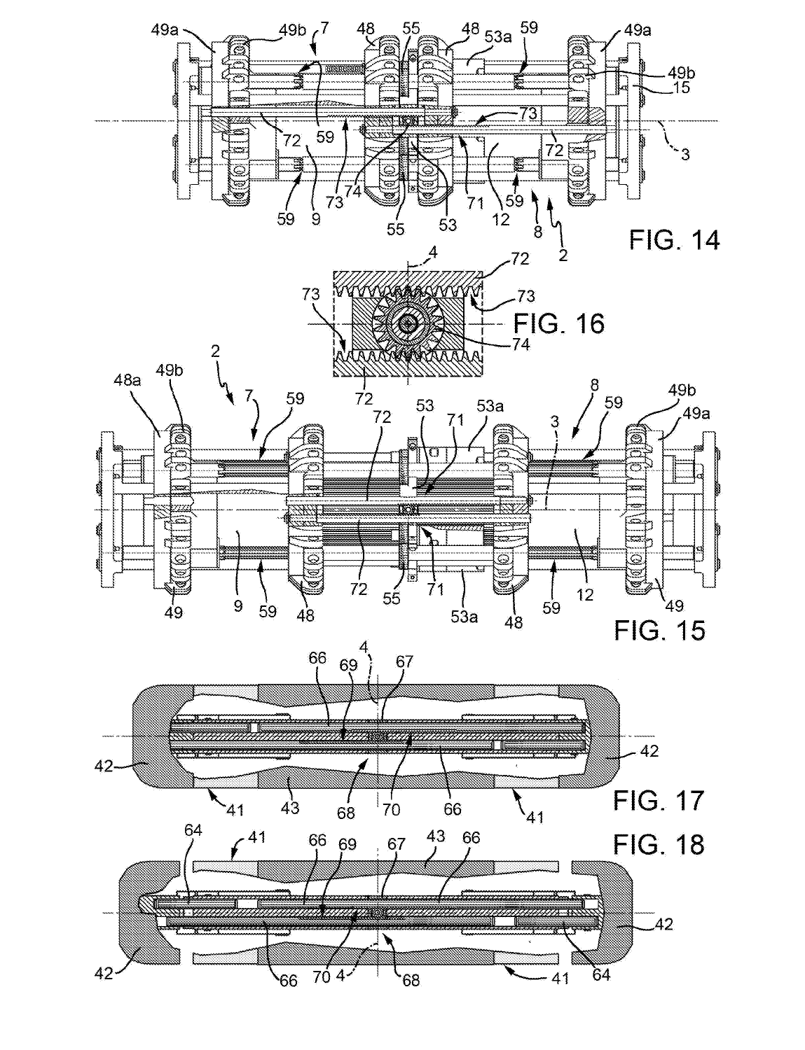

In particular, with regards to half-drum 7, the connection means comprise a collar 48 coaxial to the longitudinal axis 3 and rigidly connected to the free axial end of tubular body 9, and a collar, coaxial to the longitudinal axis 3, which is mounted in an axially sliding manner on a central portion of tubular body 9 and is composed of two collars 49a and 49b, which are physically disconnected from each other and, in the configurations of maximum radial expansion and maximum radial contraction, are arranged in contact with each other (FIGS. 14 and 15). Levers 46 of all the respective lever mechanisms 44 of half-drum 7 have one end hinged to the axially fixed collar 48 and the opposite end hinged to an internal ridge 50 of a respective segment 40 or 41 via a pin 60, which is parallel to the hinge axis 47 of the respective lever mechanism 44 and engages, in a transversally sliding manner, a slot 52 made in segment 40 or 41 and parallel to the longitudinal axis 3; the levers 45 connected to segments 40 are hinged at one end to the ridges 50 of respective segments 40 and, on the opposite end, to collar 49a, and the levers 45 connected to segments 41 are hinged at one end to the ridges 50 of respective segments 41 and, on the opposite end, to collar 49b.

The above provisions for half-drum 7 hold with regards to half-drum 8, except that in this case, the axially fixed collar 48 and the axially sliding collars 49a and 49b are connected to sleeve 16.

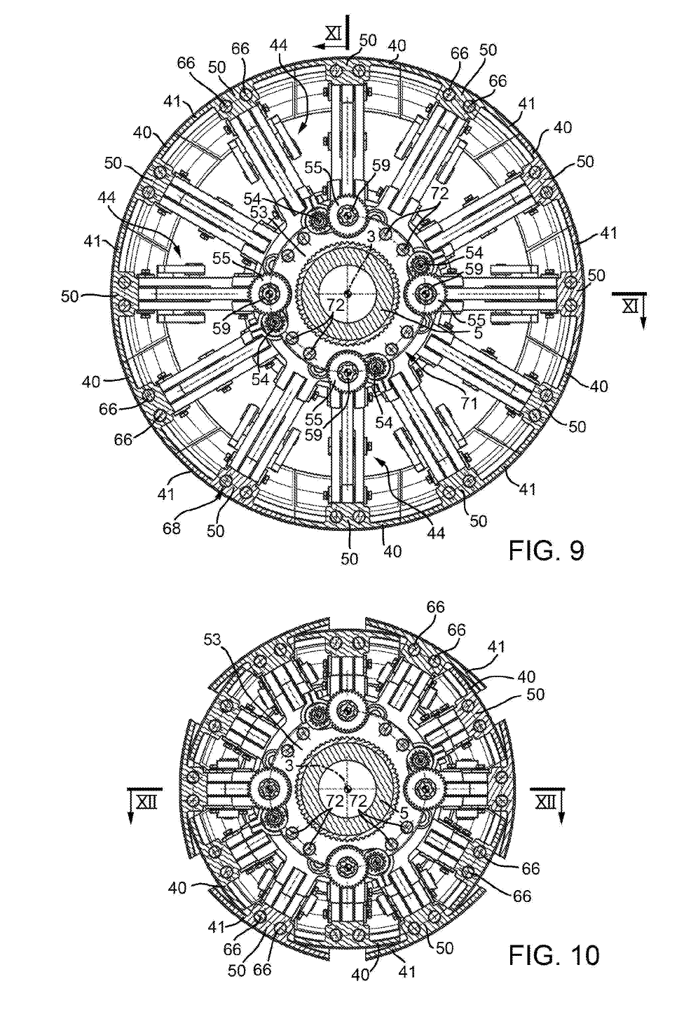

As shown in FIGS. 8 and 9, the actuator unit 39 comprises a plurality of motors 53a (FIG. 15), preferably air motors, carried by a support ring 53, which lies on the centre plane 4 and is coupled in an axially sliding manner to the splined portion 11 of the central shaft 5. The motors are distributed uniformly about the longitudinal axis 3 and each comprises an output shaft rotatable about a respective axis parallel to the longitudinal axis 3 and carrying a pinion 54 (FIG. 9), which meshes with a cogwheel 55 rotating about a respective axis 56 parallel to the longitudinal axis 3.

The cogwheel 55 is fitted on a tube 57 integral with the ring 53, coaxial to axis 56 and internally splined. The cogwheel 55 demarcates two equal portions on the tube 57, each of which is engaged in an axially sliding manner by a splined end portion 58 of a respective drive screw 59 coaxial to axis 56. At the opposite end to the splined portion 58, each drive screw 59 has an unthreaded shank, which is supported in a rotatable and axially fixed manner through the interposition of a bearing, on an annular flange 60 of tubular body 9 in the case where the drive screw 59 is part of half-drum 7, or on flange 14 of tubular body 12 in the case where the drive screw 59 is part of half-drum 8.

Between the splined portion 58 and the support shank, each drive screw 59 comprises a threaded portion 61, which engages a lead nut 62 integral with collar 49a or 49b. The drive screw 59 is preferably a recirculating ball screw coupled to a female screw of known type defining the lead nut 62.

From the above, it follows that, in use, a rotation of the drive screw 59 driven by motor 53a through rotation of the tube 57 causes the translation of lead nut 62, and therefore of collar 49a or 49b, along axis 56. Depending on the direction of rotation of the drive screw 59, the collar 49a or 49b will move away from or towards the centre plane 4, making levers 46 rotate with consequent extension or closing of pantographic lever mechanism 44 and radial movement of the segments towards the outside or inside of the drum 2.

In the example shown (FIG. 9), the actuator unit 39 comprises four motors 53a, of which two, diametrically opposed to each other, operate the six segments 40 of half-drum 7 and the six segments 40 of half-drum 8 and the other two, also diametrically opposed to each other, operate the six segments 41 of half-drum 7 and the six segments 41 of half-drum 8.

In relation to this, it is opportune to specify that only two motors would be sufficient for this purpose, with one for operating segments 40 of both half-drums 7 and 8, and the other for operating segments 41 of both half-drums 7 and 8. During radial contraction of the drum 2, the operation of the motor(s) 53a must take place in a way such that the motor(s) 53a connected to the two collars 49a via the drive screw(s) 59 are operated before the motor(s) 53a connected to the two collars 49b via the respective drive screw(s) 59. In this way, segments 40, which are driven by the axial movement of collars 49a, anticipate segments 41 in the radial movement towards the longitudinal axis 3, avoiding interference with segments 41, which partially overlap segments 40 in the configuration of maximum radial contraction.

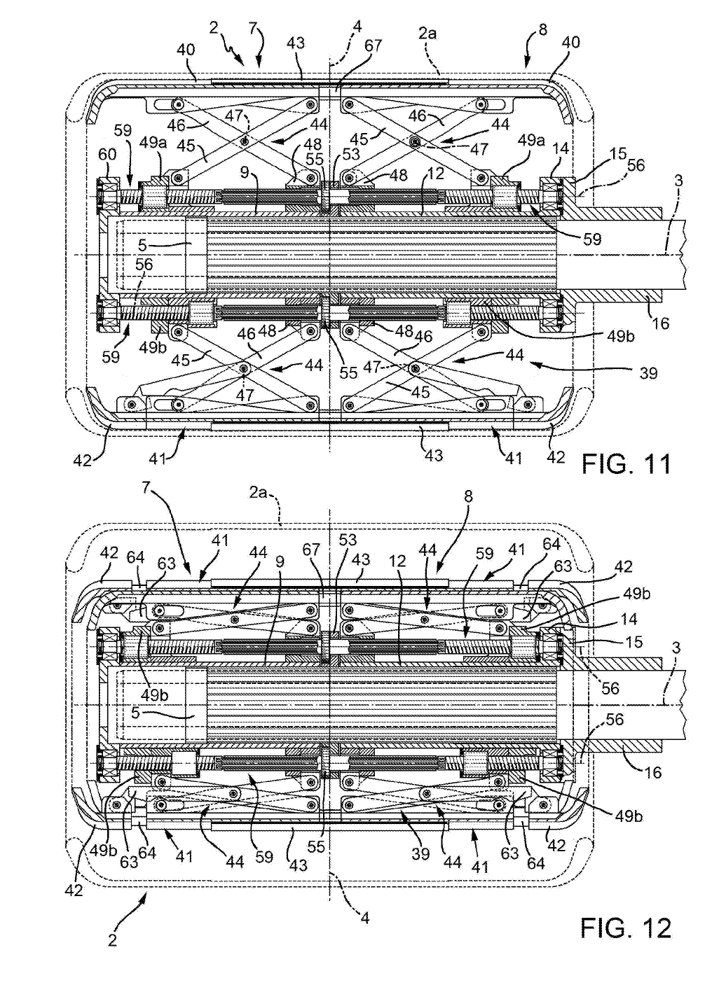

As shown in FIGS. 11 and 12, during movement from the configuration of maximum radial expansion to the configuration of maximum radial contraction, the bent end portions 42 of segments 41 move towards the outside of the drum 2 so as not to interfere with the bent end portions of segments 40, while segments 41 start to overlap segments 40. In this way, it is possible to reduce radial interference of the segments in the end areas and so achieve good radial matching of the aforesaid segments and, in consequence, a smaller diameter for the drum 2 in the radially contracted position.

To this end, each bent end portion 42 is connected to the respective lever mechanism 44 by means of a lever 63 extending between the hinge axis of the respective lever mechanism 44 and the bent end portion 42 in question, so as to push it outwards during radial contraction of the drum 2 and make it retract during radial expansion of the drum 2.

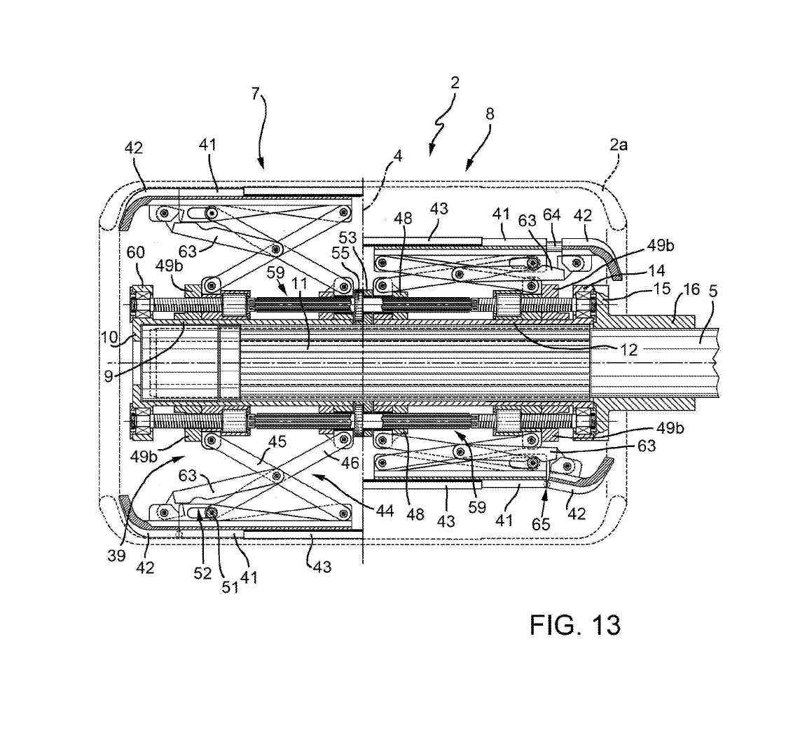

As shown in FIGS. 12 and 13, the bent end portion 42 is connected to the main portion of segment 41 by respective pin means 64, which are parallel to the longitudinal axis 3, extend between the ridge 50 of the segment 41 and the bent end portion 42 and, under the action of lever 63, constrain the bent end portion 42 to move axially towards and away from the centre plane 4.

According to the variant shown in the bottom half of FIG. 13, the bent end portion 42 is connected to the main portion of segment 41 by respective hinge means 65, which, under the action of lever 63, constrain the bent end portion 42 to rotate about a respective axis transversal to the longitudinal axis 3 so that it moves away from the longitudinal axis 3.

As shown in FIGS. 8 and 9, each central segment 43 is supported by a pair of segments 40 or 41 axially aligned with it via two rods 66, each of which is parallel to the longitudinal axis 3 and slidingly engages a respective hole made in a rib 67 integral with the central segment 43. Each of the two rods 66 also has one end engaged in a fixed manner inside a hole made in the ridge 50 of one of the two segments and the opposite end slidingly engaged in a hole made in the ridge 50 of the other of the two segments. The result is that the two rods 66 of each central segment 43 are integral with one another and with the other of the two segments axially adjacent to the central segment 43, which carries the two rods 66.

In addition to supporting and constraining the central segments 43 to the associated segments 40 or 41 aligned therewith, the pairs of rods 66 associated with the central segments 43 also define a centring device 68 designed to ensure that the central segments 43 always remain centred with respect to the centre plane 4 during axial movement of the half-drums 7 and 8.

For this purpose, as shown in FIG. 17, each of the two rods 66 connected to a central segment 43 is provided with a toothed portion 69, facing the toothed portion 69 of the other rod 66, and meshing with a synchronization wheel 70 rotatably mounted on the respective rib 67 to rotate about a respective axis orthogonal to the longitudinal axis 3. It follows that when the two half-drums 7 and 8 are axially moved away from or towards the centre plane 4, the synchronization wheel 70 ensures that, for each pair of axially aligned segments 40 or 41, the axial movement of segment 40 or 41 of one of the two half-drums is identical and specular to the axial movement of segment 40 or 41 of the other half-drum 8 or 7 and, in consequence, the respective central segment 43 remains stationary and centred with respect to centre plane 4.

As shown in FIGS. 14, 15 and 16, the drum 2 also comprises a further centring device 71 with the function of ensuring that the central ring 53 maintains a central position with respect to the axial distance of the tubular bodies 9 and 12 during the axial adjustment of the drum 2.

Centring device 71 functions in a similar way to centring device 68 and comprises a plurality of pairs of rods 72 extending between the collar 48 integral with half-drum 7 and the collar 48 integral with half-drum 8. In the example shown (FIG. 9), the drum 2 comprises four pairs of rods 72, but their number can be greater or smaller.

The rods 72 of each pair of rods 72 are each integral with a respective one of the two collars 48 and comprise respective toothed portions 73 meshing with a synchronization wheel 74, which is supported by the ring 53 and controls that, for an axial movement by one of the two tubular bodies 9 or 12, there is a correspondingly equal axial movement in the opposite direction by the other tubular body 12 or 9, at the same time keeping the centre plane 4 fixed.

The operation of the apparatus 1 is clearly understandable from the above description and does not require further explanation.

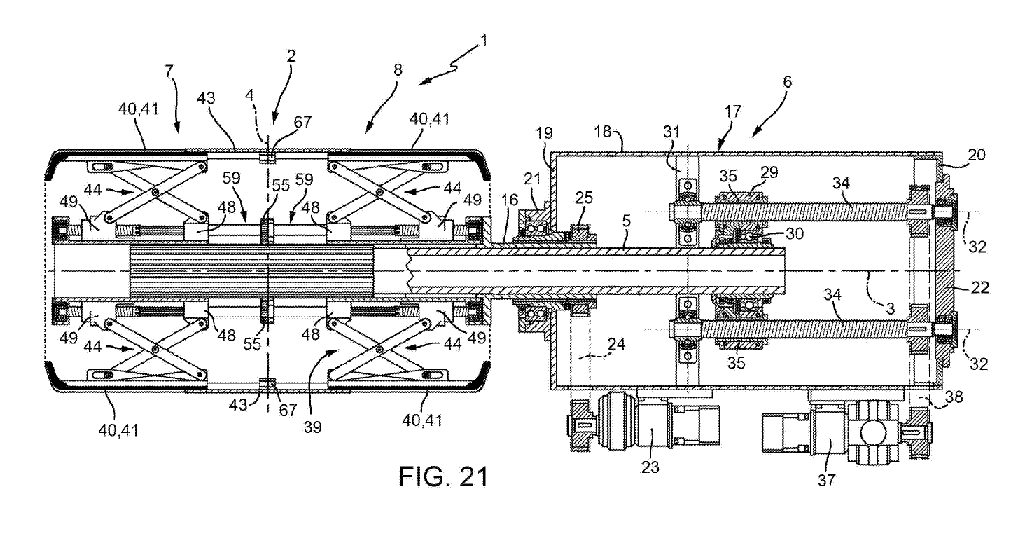

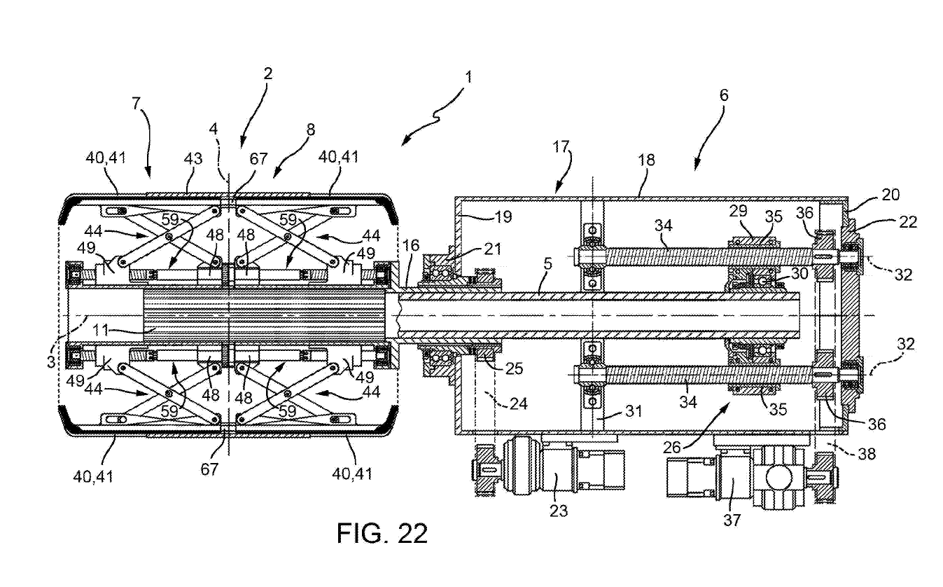

FIGS. 21 and 22 show a variant of the apparatus 1 shown in FIGS. 1 and 2. According to this variant, the axial adjustment of the drum 2 is performed by axially moving only one of the two half-drums 7 and 8 and keeping the other one stationary; therefore, the axial position of the centre plane 4 along the longitudinal axis 3 is variable depending to the axial width of the drum 2.

The apparatus 1 in FIGS. 21 and 22 differs substantially from the apparatus in FIGS. 1 and 2 only with regards to the structure of actuator device 26 that, in this case, is configured to only move the central shaft 5, and therefore half-drum 7, so as to keep sleeve 16, and therefore half-drum 8, stationary during axial adjustment of the drum.

Therefore, with respect to the previously described example, the actuator unit 26 comprises only plate 29 integral with the central shaft 5, while plate 27 integral with the sleeve 16 is not present and sleeve 16 is supported in a rotatable and axially fixed manner by the bearing support 21 mounted on end wall 19 of the frame 17. Plate 29 is coupled to screws 34 that, in this case, have only one threaded portion.

The structure of the drum 2 remains the same in both of the above-described examples. It should be noted that also in the case of a drum with a variable position centre plane, centring device 68 and centring device 71 continue to carry out their assigned functions, namely ensuring that, following an axial movement of just half-drum 7, the central segments 43 remain centred with respect to the centre plane 4 and the tubular bodies 9 and 12 remain equidistant from the centre plane 4.

In fact, with reference to the FIGS. 17 and 18, the axial movement of the collar 48 integral with tubular body 9 causes the axial movement of the rods 72 integral with the collar 48. Since the rods 72 integral with the other collar 48, which is integral with tubular body 12, are fixed, the synchronization wheels 74, which are integral with the ring 53, make the ring 53, and therefore the centre plane 4, perform a translation along the longitudinal axis 3 in the same direction as and for half the distance of the translation of tubular body 9, resulting in the tubular bodies 9 and 12 remaining equidistant from the centre plane 4.

Similarly, the axial movement of the segments 40 and 41 of half-drum 7 also cause axial movement of the respective rods 66, while the rods 66 integral with the segments 40 and 41 of half-drum 8 remain axially fixed. In consequence, the synchronization wheels 70, which are integral with the respective central segments 43, mesh on the fixed rods 66 and make the central segments 43 perform an axial movement in the same direction as and for half the distance of the axial movement of the segments 40 and 41 of half-drum 7, resulting in the central segments 43 remaining centred with respect the to the centre plane 4.

1-12. (canceled)

13. A tire building apparatus, comprising:
a drum having an axis, the drum including two shafts coaxial to the axis and two half-drums each of which is angularly coupled to a respective one of the two shafts to rotate therewith about the axis; wherein the two half-drums are specular with respect to a center plane of the drum, are axially relatively movable, and each includes a plurality of segments defining, as a whole, an outer surface of the drum;
a first actuating device configured to rotate the drum about the axis and continuously vary a distance between the two half-drums to adjust an axial width of the drum;
wherein the first actuating device is arranged outside of the drum to axially move the two half-drums via a relative telescopic movement of the respective shafts; and
a second actuating device configured to radially move the plurality of segments to cause the drum to assume a configuration of maximum radial expansion and a configuration of maximum radial contraction; each of the two half-drums includes respective first segments and second segments alternately arranged about the axis, and is axially fixed with the respective the shaft;
wherein the second actuating device is arranged on board the drum and is operable independently of the first actuating device and of the movement of the two shafts of the two half-drums;
wherein the second actuating device includes driving means including at least a first motor to simultaneously operate first segments of both of the two half-drums, and at least a second motor to simultaneously operate the second segments of both of the two half-drums.

14. The tire building apparatus according to claim 13, wherein the second actuating device includes a mechanical transmission that is arranged between the driving means and the plurality of segments, the mechanical transmission includes pantograph means to move the plurality of segments radially relative to the axis.

15. The tire building apparatus according to claim 13, wherein the first and the second motors are operable to move the first segments after the second segments during radial contraction of the drum.

16. The tire building apparatus according to claim 15, wherein each of the first and second motors includes a pneumatic motor.

17. The tire building apparatus according to claim 15, wherein each of the first and second motors includes compressed air motors.

17. The tire building apparatus according to claim 15, wherein the pantograph means include, for each of the first and second segments, a pantograph angularly connected to the respective shaft and including two levers hinged to each other to move radially with respect to the axis; the pantographs associated with the first and the second segments of a same one of the two half-drums are specular, with respect to the center plane, to the pantographs associated with corresponding first and, respectively, second segments of the other one of the two half-drums.

18. The tire building apparatus according to claim 17, wherein each pantograph includes two levers, each of which has a radially inner end hinged to the shaft of the respective one of the two half-drums and a radially outer end hinged to the respective segment; a first of the two radially inner ends in the same pantograph is connected to the respective shaft in an axially fixed manner, and a second radially inner end is connected to the respective shaft in an axially sliding manner and is connected to the driving means to be moved along the axis to and from the first radially inner end, and to cause the undeployment or the deployment of the respective pantograph.

19. The tire building apparatus according to claim 18, wherein each one of the two half-drums includes a respective tubular body that is coaxial to the axis, is angularly and axially fixed with the respective shaft and supports the pantographs associated with the plurality of segments of the respective half-drum; each tubular body has a first annular connecting portion that is angularly and axially fixed with respect to the tubular body and to which all the first internal radial ends of the respective pantographs are hinged; and a second annular connecting portion, which is coupled in an angularly fixed and axially sliding manner to the tubular body and includes two annular collars coaxial to the axis, wherein all the second radially outer ends of pantographs associated with the first segments of the respective half-drum are hinged to one of the two collars, and all the second radially inner ends of pantographs associated with the second segments of the same half-drum are hinged to the other of the two collars.

20. The tire building apparatus according to claim 19, wherein the first motor is angularly coupled to a first drive screw that is parallel to the axis and has two axial ends, each of which is connected to one of the two collars of a respective half-drum via a lead nut and screw coupling; wherein the second motor is angularly coupled to a second drive screw that is parallel to the axis and has two axial ends, each of which is coupled to the other of the two collars of a respective half-drum via a lead nut and screw coupling.

21. The tire building apparatus according to claim 15, further comprising:
wherein the drum includes a ring that is coaxial to the axis, lies on the center plane, is angularly fixed to the shafts and is axially slidable along the axis;
a first centering device to cause the ring to remain centered on the center plane during the axial adjustment of the drum;
wherein the first centering device includes at least a pair of rods, each of which is parallel to the axis and is integral with a respective shaft, and a synchronization toothed wheel that is mounted on the ring to rotate about a pin radial to the axis of the drum and meshes with two toothed portions, each formed on a respective rod.

22. The tire building apparatus according to claim 15, further comprising:
wherein the drum includes third segments, each of which is centered with respect to the center plane, is axially aligned to, and is radially movable together with, two first segments or second segment adjacent thereto;
a second centering device to cause each third segment to remain centered on the center plane during the axial adjustment of the drum;
wherein the second centering device includes, for each third segment, a pair of rods, each of which is parallel to the axis and is integral with a respective first or second segment of the pair of first or second segments adjacent thereto, and a synchronization toothed wheel, which is axially fixed to the respective third segment to rotate about a pin radial to the axis of the drum, and meshes with two toothed portions, each formed on a respective rod.

23. The tire building apparatus according to claim 17, wherein each first segment includes a main portion and an end portion bent towards the axis of the drum and defining part of a corresponding side of the drum; each end portion being axially slidably connected to the respective main portion and being connected to the pantograph of the respective first segment to move, under the action of the pantograph, from an axially retracted position to an axially extracted position when the pantograph moves from the deployed position to the closed position.

24. The tire building apparatus according to claim 17, wherein each first segment includes a main portion and an end portion bent towards the axis of the drum and defining part of a corresponding side of the drum, each end portion being hinged to the respective main portion and being connected to the pantograph of the respective first segment (to move, under the action of the pantograph, from a lowered position of continuity with the respective main portion to a raised position toward the outside of the drum, when the pantograph moves from the deployed position and the closed position.
